(19) United States
(12) Patent Application Publication
(10) Pub. No.: US 2019/0252787 A1
(43) Pub. Date: Aug. 15, 2019

(54) TAPERED SLOT ANTENNA INCLUDING POWER-COMBINING FEEDS

(71) Applicant: Raytheon Company, Waltham, MA (US)

(72) Inventors: Daniel T. McGrath, McKinney, TX (US); Brian W. Johansen, McKinney, TX (US); Michael C. Streitwieser, McKinney, TX (US)

(21) Appl. No.: 15/896,668

(22) Filed: Feb. 14, 2018

(51) Int. Cl. H01Q 13/08; H01Q 13/18; H01Q 1/38; H01Q 21/06

(52) U.S. Cl. CPC H01Q 13/085; H01Q 13/18; H01Q 13/106; H01Q 21/064; H01Q 1/38

(57) ABSTRACT

An antenna transmission system includes a dual-feedline tapered slot antenna configured to generate a radiated output signal in response to a radio frequency (RF) signal. A power divider is configured to split a source RF signal into a plurality of RF feed signals. A plurality of transmitting amplifiers convert the plurality RF feed signals into a plurality of amplified RF feed signals; and a plurality of feedlines deliver the plurality of amplified RF feed signals to the dual-feedline tapered slot antenna. The dual-feedline tapered slot antenna generates the radiated output signal in response to the plurality of amplified RF feed signals.

### BACKGROUND

The subject matter disclosed herein relates to antennas, and more particularly, to tapered slot antennas.

Tapered slot antennas can be used to transmit wideband microwave signals.

Conventional tapered slot antennas (also referred to as flared notch antennas or Vivaldi antennas), include a slot transmission line with stepped or flared openings. The slot transmission line is typically excited by a radio frequency amplifier which outputs a signal that is carried by a single antenna feedline such as, for example, a coaxial waveguide. To facilitate use at high power levels, the feedline (e.g., the coaxial waveguide) is typically oriented such that it initiates a point perpendicular to the slotline, and ends at a point at the slotline base. The coaxial outer conductor ends at one side of the slotline, and the coaxial center conductor extends across the slotline, bridging the gap. The outer and center conductors are electrically connected to the conductors forming opposite sides of the slotline. This arrangement requires all of the transmitter power to be carried in a single waveguide having an excessively large diameter.

### BRIEF DESCRIPTION

According to at least one non-limiting embodiment, an antenna transmission system includes a dual-feedline tapered slot antenna configured to generate a radiated output signal in response to a radio frequency (RF) signal. A balun is configured to split a source RF signal into a plurality of RF feed signals. A plurality of transmitting amplifiers convert the plurality of RF feed signals into a plurality of amplified RF feed signals; and a plurality of feedlines deliver the plurality of amplified RF feed signals to the dual-feedline tapered slot antenna. The dual-feedline tapered slot antenna generates the radiated output signal in response to the plurality of amplified RF feed signals.

According to another non-limiting embodiment, a dual-feedline tapered slot antenna comprises a first flared conductor and a second flared conductor separated from the first flared conductor by a slot region. A first feedline receptacle is configured to receive a first feedline, and deliver a first RF feed signal to the dual-feedline tapered slot antenna. The dual-feedline tapered slot antenna further includes a second feedline receptacle configured to receive a second feedline, and deliver a second RF feed signal to the dual-feedline tapered slot antenna. A nominal impedance of the slotline region is about one half the nominal impedance of the first and second feedlines.

According to another non-limiting embodiment, a method of transmitting a signal from a dual-feedline tapered slot antenna comprises generating, via a signal source, a radio frequency (RF) signal, and splitting the RF signal into a first feed signal and a second feed signal. The method further comprising amplifying the first feed signal to generate a first amplified feed signal, and amplifying the second feed signal to generate a second amplified feed signal. The method further comprises delivering the first and second amplified feed signals to the dual-feedline tapered slot antenna, combining the first and second amplified feed signals to electrically energize the dual-feedline tapered slot antenna and transmit the signal.

### BRIEF DESCRIPTION OF THE DRAWINGS

The following descriptions should not be considered limiting in any way. With reference to the accompanying drawings, like elements are numbered alike:

FIG. 1 illustrates an antenna transmission system including a dual-feedline tapered slot antenna according to a non-limiting embodiment;

FIG. 2 illustrates a dual-feedline tapered slot antenna according to a non-limiting embodiment;

FIGS. 3A, 3B and 3C are a series of views illustrating an installation of a plurality of feedlines in a dual-feedline tapered slot antenna according to a non-limiting embodiment; and

FIGS. 4A and 4B are a series of views illustrating an installation of a plurality of feedlines in a dual-feedline tapered slot antenna according to another non-limiting embodiment.

### DETAILED DESCRIPTION

A detailed description of one or more embodiments of the disclosed system, apparatus and method are presented herein by way of exemplification and not limitation with reference to the Figures.

A typical individual slot antenna includes a pair of flared conductors separated by a slot that opens progressively to a radiating mouth. Each flared conductor has a horizontal dimension which decreases progressively in length from the lower end (i.e. base) of the flared conductor to the upper end thereof (i.e., the tip). The base of the flared conductors are spaced apart a small distance from each other by a slotline (also referred to as a slotline gap), while their tips are spaced a larger distance from each other, thereby forming the tapered slot between the two flared conductors.

A conventional tapered slot antenna configures only a single feed line to carry the input signal. For example, a signal generated by a signal source is delivered to a single feedline such as a coaxial waveguide, which is recessed into the base of only one of the flared conductors. The coaxial waveguide includes a center conductor that is surrounded by an outer conductor, and an intermediate dielectric layer that insulates the center conductor from outer conductor. The outer conductor is electrically connected to one flared conductor, and terminates on the near side of the slotline. The center conductor extends across the slotline gap and connects to the opposing flared conductor. As the power handled by the coaxial waveguide increases, the intermediate dielectric layer may begin to breakdown. To support progressively higher power requires increasing the waveguide radius. However, increasing the coaxial waveguide radius to excessive dimensions, or beyond a critical radius can cause degradation to signal quality.

Various non-limiting embodiments described herein provide a tapered slot antenna including dual power-combining feedlines. Thus, unlike conventional tapered slot antennas having only a single feedline, at least one embodiment implements two individual feedlines (e.g., two individual coaxial waveguides) in a single tapered slot antenna. In addition, at least one embodiment selects slotline dimensions of a tapered slot antenna so that the characteristic impedance of the antenna is one half that of two individual coaxial waveguides.

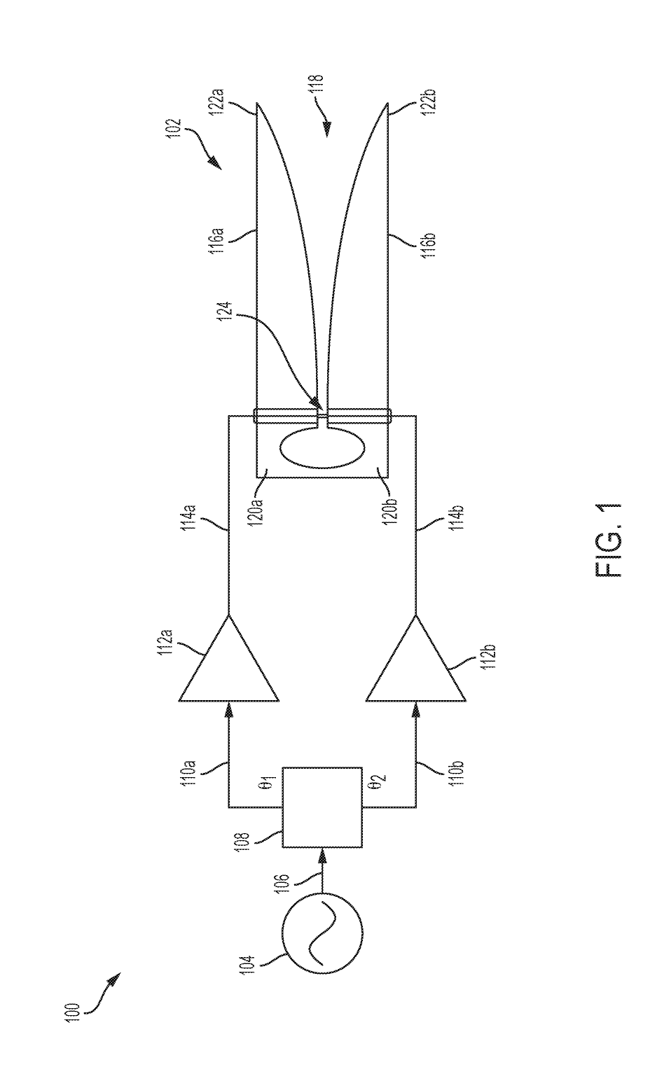

With reference now to FIG. 1, an antenna transmission system 100 including a dual-feedline tapered slot antenna 102 is illustrated according to a non-limiting embodiment. The antenna transmission system 100 implements a signal source 104 to generate a signal 106. The signal 106 is divided using a power divider device such as a balun 108, for example, so that the two signals 110a and 110b are approximately equal in power and approximately 180 degrees out-of-phase. The two signals are amplified by the amplifiers 112a and 112b, then delivered to the dual-feedline tapered slot antenna 102, which radiates an electromagnetic field, which can serve as a radiated output signal.

The dual-feedline tapered slot antenna 102 is in signal communication with the plurality of feedlines to receive the amplified RF feed signals from the plurality of transmitting amplifiers 112a and 112b. The dual-feedline tapered slot antenna 102 includes a pair of flared conductors 116a and 116b composed of an electrically conductive material such as metal, for example. A slotline gap 124 is interposed between the 1 the pair of flared conductors 116a and 116b. In at least one embodiment, the dimensions of the slotline gap 124 are chosen so that its characteristic impedance is one half that of the feedlines (e.g. coaxial waveguides) 114a and 114b. More generally, for N separate coaxial waveguides with characteristic impedance Z₀, the dimensions of the slotline gap 124 are selected to achieve a slotline impedance of Z₀/N.

The slotline gap 124 can also be filled with a dielectric material having a high breakdown strength (not shown in FIG. 1). In high-power applications, for example, the slotline gap can be filled (either partially or fully) with a solid dielectric insulator or filler having a breakdown strength that is higher than that of air. Example materials with high breakdown strength and low radio frequency loss are Polytetrafluorethylene, Cyanate-Ester, Rexolite (cross-linked polystyrene and divinyl Benzene) and Polyetherimide.

The antenna transmission system 100 operates to deliver a balanced combination of the first and second RF feed signals 110a and 110b to the dual-feedline tapered slot antenna 102. That is, the plurality of RF feed signals are delivered to the dual-feedline tapered slot antenna 102 having the same, or approximately the same, amplitude, and either a matching phase, or mismatched phase, based on the direction of the feedlines 114a and 114b input to the dual-feedline tapered slot antenna 102. If the signals are not balanced, there will be reflection back into the transmitting amplifiers 112a and 112b.

Still referring to FIG. 1, the first flared conductor 116a receives a first feedline 114a and the second flared conductor 116b receives a second feedline 114b. Accordingly, the first and second feedlines 114a and 114b are fed to the dual-feedline tapered slot antenna 102 in opposite directions (see FIG. 1). In this example, the first and second feedlines 114a and 114b each have a characteristic impedance of 50 Ohms (50Ω). The slotline 124 has a characteristic impedance of 25Ω. Since the feedlines 114a and 114b will not be impedance-matched to the slotline, portions of the signals they carry will be reflected from the junction 124 back towards the amplifiers 112a and 112b. However, approximately equal portions of out-of-phase signals are cross-coupled between feedlines, 114a to 114b and vice-versa, and cancel the reflected portions.

In another embodiment, either the first flared conductor 116a or the second flared conductor 116b receives both of the first feedline 114a and the second feedline 114b. Accordingly, the first and second feedlines 114a and 114b are fed to the dual-feedline tapered slot antenna 102 in the same direction (not shown in FIG. 1). In this scenario, the first and second feed lines 114a and 114b are delivered to the dual-feedline tapered slot antenna 102 with the same, or approximately the same, phase, thereby achieving the same signal reflection cancellation effect described above. In this scenario, 108 is an equal-phase, equal-amplitude power divider instead of a balun. Although a tapered antenna designed is described in detail above, it should be appreciated that the aforementioned descriptions can be implemented with other antenna designs including, but not limited to, a stepped-slot antenna.

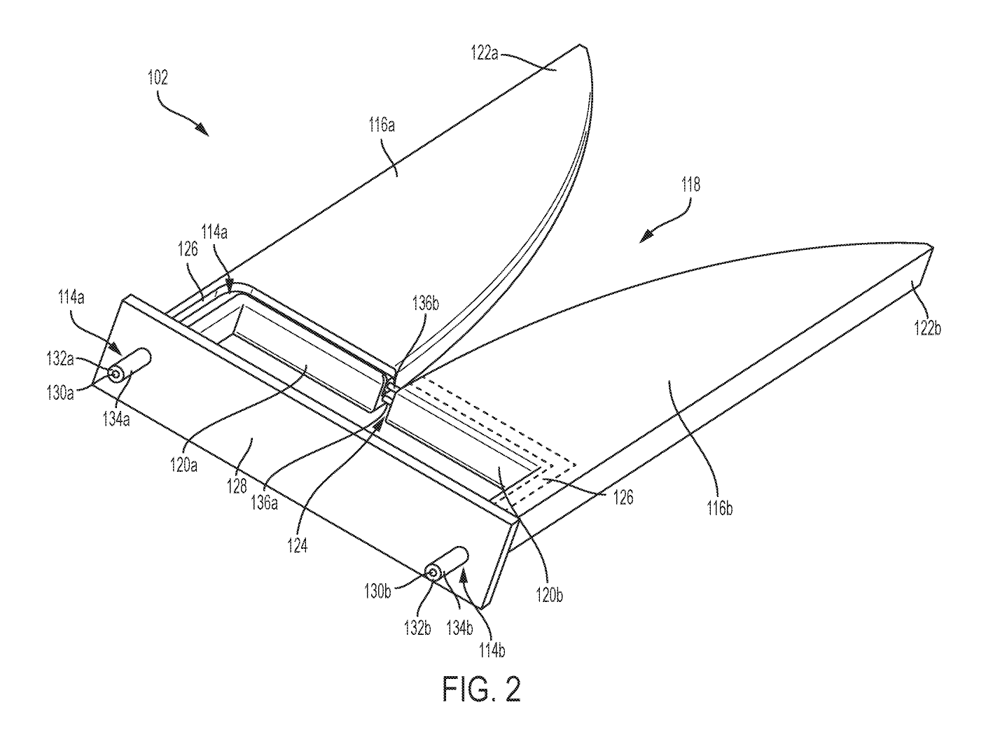

Turning now to FIG. 2, a dual-feedline tapered slot antenna 102 is illustrated according to a non-limiting embodiment. Various components of the dual-feedline tapered slot antenna 102 are described in detail above, and therefore will not be repeated for the sake of brevity. Each flared conductor 116a and 116b includes a feedpath 126 formed at its lower end 120a and 120, respectively. The feedpath 126 can either be exposed or formed as a tunnel or inlet that extends through the body of a respective flared conductor 116a and 116b. Each feedpath 126 begins at a base of the dual-feedline tapered slot antenna 102, and extends parallel with the outer edge of a respective flared conductor 116a and 116b. At an area located around the lower end 120a and 120b, the feedpath turns about ninety-degrees, and extends horizontally along the lower end where it reaches the slotline gap 124.

The feed lines 114a and 114b are fed through the base 128 and into a respective feedpath 126, where they follow the feedpath direction. In at least one embodiment, the feedlines 114a and 114b are constructed as coaxial waveguides 114a and 114b. The coaxial waveguides 114a and 114b have respective center conductors 130a and 130b, which are concentrically surrounded by respective sleeves 132a and 132 composed of a dielectric material such as Polytetrafluoroethylene, for example. The sleeves 132a and 132 are each surrounded by an outer shielding 134a and 134b.

The second end of each coaxial waveguide 114a and 114b includes an extended portion 136a and 136b of the center conductor 130a and 130b, which extends horizontally across the slotline gap 124. Each extended portion 136a and 136b is received within an opposite facing flared conductor 116a and 116b. For example, the first coaxial waveguide 114a extends through the first feedpath 114a of the first flared conductor 116a until the second end reaches the slotline gap 124. The extended portion 136a of its center conductor 130a extends across the slotline gap 124 and is received in a receptacle (not shown in FIG. 2) formed in the opposing second flared conductor 116b. Similarly, the second coaxial waveguide 114b extends through the second feedpath 114a of the second flared conductor 116b until the second end reaches the slotline gap 124. The extended portion 136b of its center conductor 130b extends across the slotline gap 124 and is received in a receptacle formed in the opposing first flared conductor 116a. The center conductors 130a and 130b are the only portions of each coaxial waveguide 114a and 114b that extend across slotline gap 124. The extended portions 136a and 136b can be secured to respective flared conductors 116b and 116a using solder, for example, so as to electrically couple the flared conductor 116a and 116b to the respective extended portion 136b and 136a.

In at least one embodiment, the outer shielding 134a and 134b, along with the insulating sleeves 132a and 132b are trimmed so that only the center conductor 136a and 136b extends through the slotline region (e.g., across the slotline gap 124) to be electrically connected to the opposite-facing flared conductor 116b and 116a. The outer shielding 134a and 134b can be electrically connected to its near-side flared conductor 116a and 116b. Metal brackets or cable clamps (not shown in FIG. 2) may be implemented to clamp the coaxial waveguides 114a and 114b in place, at the same time forming extensions of the flared conductors 116a and 116b. A dielectric filler (not shown in FIG. 2) can then be bonded in place using a resin with similar electrical properties. The resin fills any air gaps around the center conductors 130a and 130b.

The first coaxial waveguide 114a includes a first end connected to an output of the first transmission amplifier 112a (not shown in FIG. 2), and a second end disposed adjacent the slotline gap 124. Similarly, the second coaxial waveguide 114b includes a first end connected to an output of the second transmission amplifier 112b (not shown in FIG. 2) and a second end disposed adjacent the slotline gap 124. Thus, the second end of the first coaxial waveguide is disposed on a first side of the slotline gap 124, while the second end of the second coaxial waveguide is disposed on the opposite side of the slotline gap 124. As described above, however, this arrangement is not present in the case where the first and second coaxial waveguides are fed to the same side of the dual-feedline tapered slot antenna 102, i.e., are fed to a common flared conductor 116a or 116b.

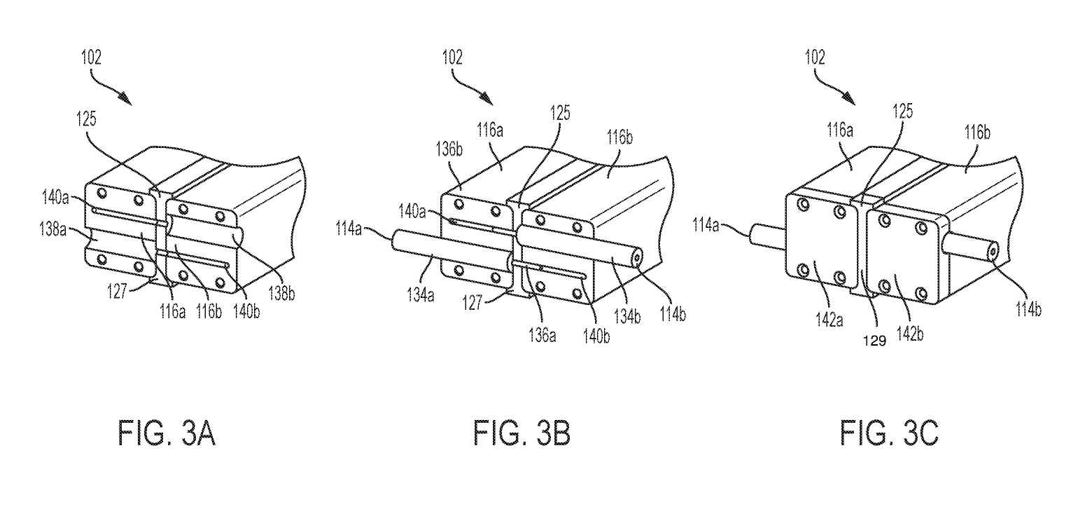

FIG. 3 illustrates an assembly that prevents the formation of blind connections. Instead, the metal surfaces to be mated are accessible and visible for soldering or welding, and the dielectric surfaces are accessible and visible for application of a bonding resin. The installation of a plurality of feedlines 114a and 114b in a dual-feedline tapered slot antenna 102 is illustrated according to a non-limiting embodiment. In the example, the feedlines 114a and 114b are constructed as coaxial waveguides, and are input to opposing flared conductors 116a and 116b of the dual-feedline tapered slot antenna 102 as illustrated in FIG. 3B. Structural details of the coaxial waveguides 114a and 114b are described in detail above, and therefore will not be repeated for the sake of brevity.

The first and second flared conductors 116a and 116b are separated from one another by a slotline region 125. In some embodiments, the slotline region 125 exists as an air gap that defines the slotline gap 124 described above. In at least one embodiment illustrated in FIG. 3, the slotline region 125 contains a dielectric filler 127 that fills the slotline gap located in the slotline region 125. The dielectric filler 127 can be composed of a dielectric material having high breakdown strength and low radio frequency loss, such as those listed previously.

The first and second flared conductors 116a and 116b each include outer shielding receptacles 138a and 138b, along with center conductor receptacles 140a and 140b. The outer shielding receptacles 138a and 138b are sized to receive the outer shielding 134a and 134b, respectively, while the center conductor receptacles 140a and 140b are sized smaller to receive the extended portion 136a and 136b of respective center conductors. The center conductor receptacle 140a formed in the first flared conductor 116a is horizontally aligned with the outer shielding receptacle 138b formed in the second flared conductor 116b. Similarly, the center conductor receptacle 140b formed in the second flared conductor 116b is horizontally aligned with the outer shielding receptacle 138a formed in the first flared conductor 116a.

Referring to FIG. 3B, the first coaxial waveguide 114a is attached so that its outer shield 134a meets the outer shielding receptacle 138a and its inner conductor 136a meets the center conductor receptacle 140b and a recess in the dielectric filler 127. Similarly, the second coaxial waveguide 114b is attached so that its outer shield 134b meets the outer shielding receptacle 138b and its inner conductor 136a meets the center conductor receptacle 140b and a recess in the dielectric filler 127.

Turning now to FIG. 3C, cable clamps 142a and 142b are fastened against the lower ends of the first and second flared conductors 116a and 116b to clamp the coaxial waveguides 114a and 114b in place. The cable clamps 142a and 142b also form an extension at the lower ends of the flared conductors 116a and 116b, while having a thickness that achieves a co-planar front surface with respect to the dielectric insert 129. In at least one embodiment, the cable clamps 142a and 142b can be composed of the same material (e.g., metal) as that of the first and second flared conductors 116a and 116b. The insert 129 can be of the same dielectric material as 127, and shaped so that it forms an extension of 127 and can be bonded in place using a compatible resin adhesive.

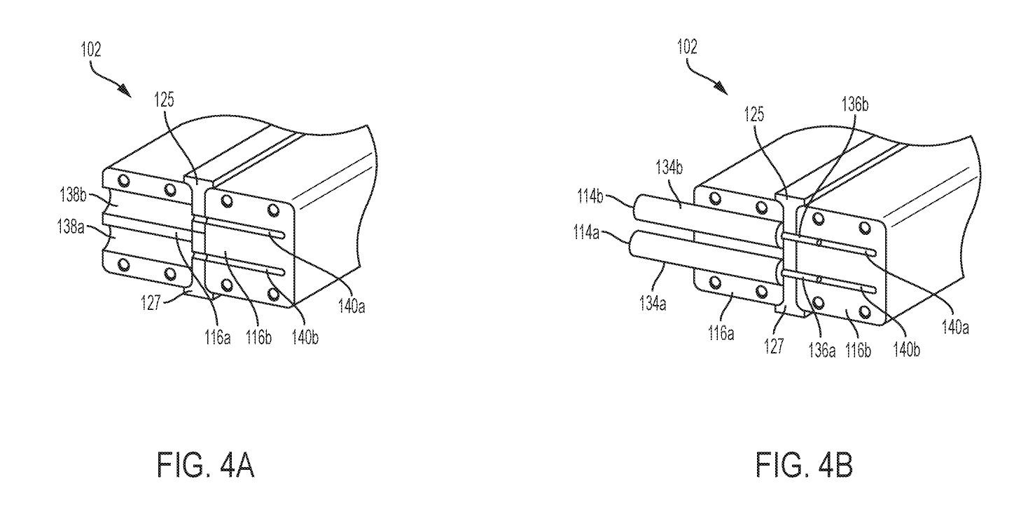

The installation of a plurality of feedlines 114a and 114b in a dual-feedline tapered slot antenna 102 is illustrated in FIGS. 4A and 4B according to another non-limiting embodiment. In this example, a pair of outer shielding receptacles 138a and 138b are formed on a common side of the dual-feedline tapered slot antenna 102 as illustrated in FIG. 4A. Accordingly, the coaxial waveguides 114a and 114b can be attached to a common flared conductor (e.g., the first flared conductor 116a). That is, the first and second coaxial waveguides 114a and 114b are attached to a same side of the dual-feedline tapered slot antenna 102. To facilitate the same-side feedline input, the first flared conductor 116a includes a first outer shielding receptacle 138a and a second outer shielding receptacle 138b. The second flared conductor 116b includes a first center conductor receptacle 140a and a second center conductor receptacle 140b. The first and second center conductor receptacles 140a and 140b are horizontally aligned with respective shielding receptacles 138a and 138b.

Referring to FIG. 4B, the first coaxial waveguide 114a is attached so that its outer shield 134a meets the outer shielding receptacle 138a and its inner conductor 136a meets the center conductor receptacle 140b and a recess in the dielectric filler 127. Similarly, the second coaxial waveguide 114b is attached so that its outer shield 134b meets the outer shielding receptacle 138b and its inner conductor 136a meets the center conductor receptacle 140b and a recess in the dielectric filler 127.

As described above, various non-limiting embodiments provide a tapered slot antenna including dual power-combining feedlines. Unlike conventional tapered slot antennas having only a single feedline, at least one embodiment implements two individual feedlines (e.g., two individual coaxial waveguides) in a single tapered slot antenna. The dual feedlines deliver feed signals having either a mis-matched phase (e.g., 180 degrees out-of-phase) or a matched phase, so as to reduce or even eliminate the level of signal reflection returned back to the transmitting amplifiers which output the feed signals.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An antenna transmission system comprising:
a dual-feedline tapered slot antenna configured to generate a radiated output signal in response to a radio frequency (RF) signal;
a power divider configured to split a source RF signal into a plurality of RF feed signals;
a plurality of transmitting amplifiers configured to convert the plurality RF feed signals into a plurality of amplified RF feed signals; and
a plurality of feedlines configured to deliver the plurality of amplified RF feed signals to the dual-feedline tapered slot antenna,
wherein the dual-feedline tapered slot antenna generates the radiated output signal in response to the plurality of amplified RF feed signals.

2. The antenna transmission system of claim 1, wherein the plurality of transmission amplifiers includes a first transmission amplifier that outputs a first amplified RF feed signal to a first feedline among the plurality of feedlines, and a second transmission amplifier that outputs a second amplified RF feed signal to a second feedline among the plurality of feedlines.

3. The antenna transmission system of claim 2, wherein the dual-feedline tapered slot antenna includes a first flared conductor and a second flared conductor arranged opposite the first flared conductor, the first and second flared conductors separated from one another by a slotline region having a nominal impedance that is one half that of the first and second feedlines.

4. The antenna transmission system of claim 3, wherein the first flared conductor receives the first feedline and the second flared conductor receives the second feedline.

5. The antenna transmission system of claim 4, wherein the first amplified RF feed signal has a first phase (θ₁), and the second amplified RF feed signal has a second phase (θ₂) that is shifted to be mismatched with respect to the first phase (θ₁).

6. The antenna transmission system of claim 5, wherein the second phase (θ₂) is shifted 180 degrees with respect to the first phase (θ₁).

7. The antenna transmission system of claim 3, wherein one of the first flared conductor or the second flared conductor receives both the first feedline and the second feedline.

8. The antenna transmission system of claim 7, wherein the first amplified RF feed signal has a first phase (θ₁), and the second amplified RF feed signal has a second phase (θ₂) that matches the first phase (θ₁).

9. The antenna transmission system of claim 3, wherein the first and second feedlines are coaxial waveguides, and wherein the slotline region includes a dielectric material disposed therein.

10. A dual-feedline tapered slot antenna comprising:
a first flared conductor and a second flared conductor separated from the first flared conductor by a slot region;
a first feedline receptacle configured to receive a first feedline, the first feedline configured to deliver a first RF feed signal to the dual-feedline tapered slot antenna; and
a second feedline receptacle configured to receive a second feedline, the second feedline configured to deliver a second RF feed signal to the dual-feedline tapered slot antenna,
wherein a nominal impedance of the slotline region is about one half the nominal impedance of the first and second feedlines.

11. The dual-feedline tapered slot antenna of claim 10, wherein the first flared conductor comprises:
a first outer shielding receptacle having a first size, and configured to receive a first outer shielding of the first feed line; and
a second outer shielding receptacle having the first size, and configured to receive a second outer shielding of the second feed line, and
wherein the second flared conductor comprises:
a first center conductor receptacle having a second size that is smaller than the first size, and configured to receive a first center conductor of the first feed line while blocking reception of the first outer shielding; and
a second center conductor receptacle having the second size, and configured to receive a second center conductor of the second feed line while blocking reception of the second outer shielding.

12. The dual-feedline tapered slot antenna of claim 10, wherein the first flared conductor comprises:
a first outer shielding receptacle having a first size, and configured to receive a first outer shielding of the first feed line; and
a first center conductor receptacle having a second size that is smaller than the first size, and configured to receive a center conductor of the second feed line while blocking reception of an outer shielding of the second feed line, and
wherein the second flared conductor comprises:
a second outer shielding receptacle having the first size, and configured to receive the outer shielding of the second feed line, and
a second center conductor receptacle having the second size, and configured to receive a center conductor of the first feed line while blocking reception of the outer shielding of the first feed line.

13. A method of transmitting a signal from a dual-feedline tapered slot antenna, the method comprising:
generating, via a signal source, a radio frequency (RF) signal;
splitting the RF signal into a first feed signal and a second feed signal;
amplifying the first feed signal to generate a first amplified feed signal, and amplifying the second feed signal to generate a second amplified feed signal;
delivering the first and second amplified feed signals to the dual-feedline tapered slot antenna; and
combining the first and second amplified feed signals to electrically energize the dual-feedline tapered slot antenna and transmit the signal.

14. The method of claim 13, wherein delivering the first and second amplified feed signals comprises delivering the first and second amplified feed signals to opposite sides of the dual-feedline tapered slot antenna.

15. The method of claim 14, wherein delivering the first and second amplified feed signals further comprises:
delivering the first amplified feed signal to a first flared conductor of the dual-feedline tapered slot antenna; and
delivering the second amplified feed signal to a second flared conductor of the dual-feedline tapered slot antenna, the second flared conductor disposed opposite from the first flared conductor.

16. The method of claim 15, further comprising delivering the first amplified feed signal at first phase, and delivering the second amplified feed signal at second phase different from the first phase.

17. The method of claim 16, wherein the second phase is shifted 180 degrees out-of-phase with respect to the first phase.

18. The method of claim 13, wherein delivering the first and second amplified feed signals comprises delivering the first and second amplified feed signals to a same side of the dual-feedline tapered slot antenna.

19. The method of claim 18, wherein delivering the first and second amplified feed signals further comprises:
delivering the first amplified feed signal to a first flared conductor of the dual-feedline tapered slot antenna; and
delivering the second amplified feed signal to the first flared conductor of the dual-feedline tapered slot antenna.

20. The method of claim 19, further comprising delivering the first amplified feed signal at a first phase, and delivering the second amplified feed signal at second phase that matches the first phase.
